(19) United States
(12) Patent Application Publication
(10) Pub. No.: US 2003/0233570 A1
(43) Pub. Date: Dec. 18, 2003

(54) Authenticating and using digital objects

(76) Inventors: Robert E. Kahn, McLean, VA (US); Patrice Lyons, McLean, VA (US)

Correspondence Address: FISH & RICHARDSON PC, 225 FRANKLIN ST, BOSTON, MA, 02110, US

(21) Appl. No.: 10/405,322

(22) Filed: Apr. 2, 2003

Related U.S. Application Data
(60) Provisional application No. 60/369,591, filed on Apr. 2, 2002.

(51) Int. Cl. H04L 9/32; G06F 17/60

(52) U.S. Cl. 713/200; 713/181; 705/51

(57) ABSTRACT

One or more portions of a digital object are authenticated using verification information contained in a unique persistent identifier for the object as a whole.

This application is entitled to and claims the benefit of the priority of the filing date of provisional U.S. patent application serial No. 60/369,591, filed Apr. 2, 2002, which is incorporated in its entirety by reference.

### BACKGROUND

This description relates to authenticating and using digital objects.

The term digital object is intended to mean the kind of digital object described in U.S. Pat. No. 6,135,646, incorporated here by reference in its entirety. The digital object has an identifier also called a handle in that patent.

### SUMMARY

A means for authenticating digital objects is described that relies on each such objects unique persistent. A means of producing, issuing and circulating digital objects is described along with a means of identifying uniquely the computational facility holding the digital object, verifying the information represented in each such object, and securely transferring the digital object efficiently from one party to another.

Other advantages and features will become apparent from the following description and from the claims.

### DESCRIPTION

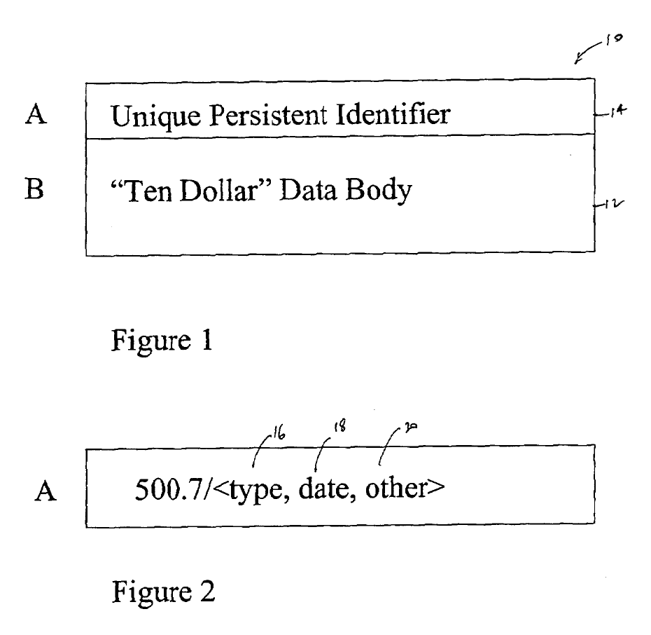

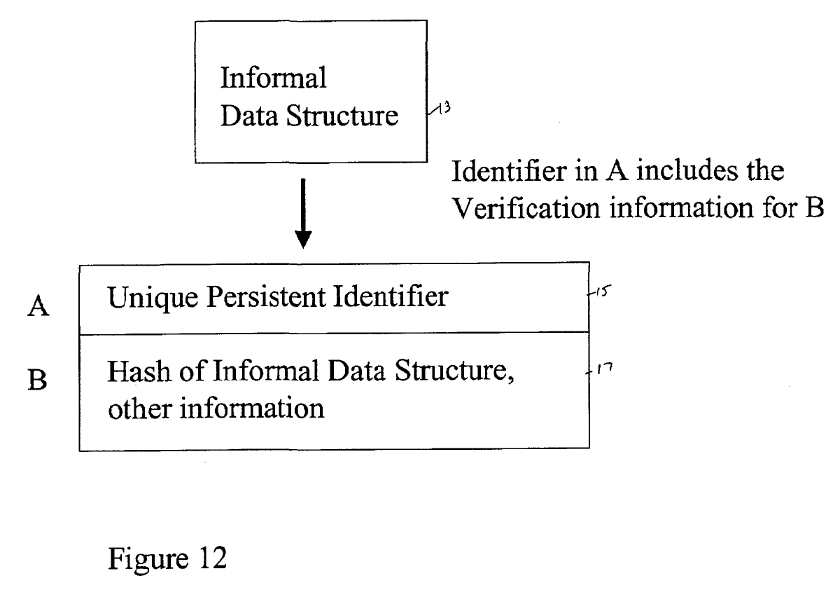

FIGS. 1, 3, 5, 10, and 12 show digital objects.

FIGS. 2, 4, 6, and 11 show identifiers.

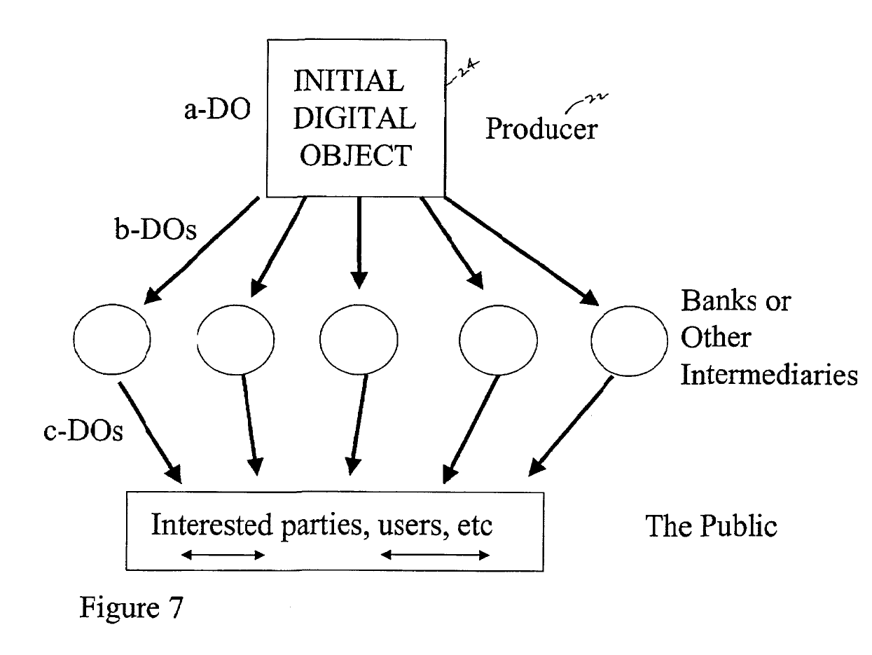

FIGS. 7 through 9 are schematic views of activities with respect to digital objects and identifiers.

As discussed below, digital objects can be authenticated using the objects' unique persistent identifiers. Digital objects may be produced, issued and circulated with authenticity. The computational facility storing the digital object, which is typically a machine, device or software system, and a party that owns or controls the digital object may be identified uniquely. The information represented as a data structure in each such object may be verified. The digital object may be safely transferred from one party to another.

The representation of information as a data structure fixed in a tangible form such as paper is a basic element in commerce. The use of such structures is so ubiquitous that they are often taken for granted in daily life. For example, a businessman will take delivery of a new computer, desk, photocopy machine or some other good or service without a second thought about the validity of the process being used. This is not a new development. For example, data structures such as “bills of lading” were used at least as early as the thirteenth century.

The representation of information as a data structure in digital form can also be used in commerce and transferred from one party to another either directly or using electronic mail or other computer systems. In the form of a digital object, the data structure includes a unique persistent identifier, which may be used in a trusted resolution process or system to access the object, to perform other operations on the object, or to obtain related information about the object. The identifier, while intrinsically part of such a data structure, may also be transferred between parties itself in lieu of the entire data structure. In general, such a digital object could be issued by an authorizing or issuing agency whose identity, along with an indication of the type of data structure and other relevant information, might be present in the identifier. Examples of other relevant information might be a fingerprint, a series number or serial number; and a signature over some portion of the data structure by the authorizing or issuing agency. In some examples, the digital object could include a representation of value such as “ten dollars” although the techniques are more broadly applicable.

The goal of at least some of the techniques described here is to insure that the data body of a digital object in a given situation is the same data body that was initially included with the identifier and that only one party maintains control or ownership of a particular digital object at a given time. Such digital objects may be transferred from one party to another with minimal risk of fraud. The authentication of a digital object whether in a network environment or not, whether contained in a computer system or not, and whether contained in a storage medium or in transit.

By “data body” we mean the portion of a digital object that is not its identifier. The content of the data body and of the identifier may differ depending on the circumstances in which the digital object is created and used. In most cases, the identifier carries validation information, such as a fingerprint, of everything after the identifier, namely the data body portion with or without a separate digital signature.

One way to insure a correspondence between a digital object and its identifier is by using a trusted party to maintain the correspondence. However, if the trusted party violates its fiduciary duties and does not accurately maintain the direct correspondence between the identifier and the digital object, another means is needed to insure that correspondence. Another concern is the possible corruption of the digital object, for example, when the digital object is in transit, or when some other operation is performed on the digital object, or where the use of traditional error checking fails.

If, upon request, one party delivers a putative digital object that contains information that purports to be sufficient to authenticate the data body of the digital object, either party can use the verification information included as part of the identifier (sometimes referred to as validation information) to determine whether the data body is one associated with the identifier. However, if a party does not possess the identifier (containing the validation information of the data body, the party would have to trust that the other party produced the correct digital object in the first place (with or without an accompanying statement about verification of the digital object). In reality, this assumption of trust may not be a valid assumption.

In some implementations of the method described here, the verification information is placed directly in the identifier for the digital object. Additional information, such as a length of the object, and type of authentication used, may also be contained in the identifier. Thus, given an identifier, a party can determine if the object produced by a computational facility (or in some other fashion directly by the party) is authentic by using the verification information in the identifier to authenticate the object. The article entitled Representing Value as Digital Objects: A Discussion of Transferability & Anonymity by Robert E. Kahn and Patrice A. Lyons, dated May 2001 and available on the Internet at http://www.dlib.org/dlib/may01/kahn/05kahn.html, briefly mentions the use of fingerprints in identifiers in the context of using digital objects in commerce.

Implementations of the verification mechanism can make use of sufficiently strong encryption techniques that cannot be subverted straightforwardly. There are many such encryption techniques widely known to be able to provide this capability for strong protection via encryption and are not recited here.

We now describe how a digital object, incorporating information in which there may be rights, interests, or value, can come into being. While the examples discussed here are drawn from the financial world, digital objects incorporating such information will be important in a wide variety of disciplines such as medicine, military, law, and collaborative research. For example, the techniques would be useful when a doctor seeks to verify the current recommended dosage of medication from a pharmaceutical company; when the guidance mechanism of ordnance verifies new targeting coordinates; when a lawyer verifies the wording of a court decision; or when a group leader coordinates the efforts of several scientists involving scientific data from various remote research facilities using the Internet.

For purposes of the specific illustrations discussed in detail below, we assume there are made publicly known a list of authorized institutions that can create or disseminate digital objects having “value”, for example, electronic versions of currency. Such a list might include the Federal Reserve Bank, the U.S. Mint, authorized banking institutions, local government entities, and/or selected brokerage firms. We also assume the existence of a trusted and secure means of resolving identifiers such as provided by the Corporation for National Research Initiatives (CNRI) Handle System (see www.handle.net).

In this example, such digital objects, including their identifiers are called “digital objects of value.” Associated handle records, which provide resolution information over a network, are created by one of the authorized institutions. When authorizes, these handle records, or portions thereof, are supplied upon request over the network by the handle system. Each digital object is stored in a computational facility on a network with a form of access control. In the handle system, identifiers have the form “prefix/suffix” where the suffix can be any string of bits and the prefix is a dotted string of characters such as 500, or 500.7, or 500.Name or 500.X.Y. In this example, the string 500 is assumed to be uniquely associated with one of the authorized institutions mentioned above.

In one example by which such an institution might produce digital objects of value, the authorized institution issues a new series of digital “ten dollar” objects 10 each including a data body 12 and a unique persistent identifier 14 as shown in FIGS. 1 and 2. As shown in FIG. 2, the identifier includes a type 16, which could refer to ten dollars, a date 18, which could be the date of issuance, and other information 20, for example, a serial number or a set of serial numbers.

The identifier can only be inserted into the handle system by an authorized administrator for the digital object (e.g., by the party who has control over the digital object) through the use of a private key associated with a public key held in the handle system for the digital object. The private key would normally not be known to the public or to the handle system. Further, the public key may not actually be known to the public; and the controlling party may or may not be known to the handle system in this case either. The controlling party that has the private key (of the public/private key pair), or has an authorization string computed using the private key, is allowed by the handle system to make the permitted changes to the handle system.

In this example, the data body denotes a ten dollar data structure that we presume cannot be easily guessed and thus not easily created by others. In one instance, the data body may also include an appropriate digital signature (e.g., of the institution or agent that produced it); however, the use of a digital signature in the data body portion of a digital object is not a requirement for the system to work and may be omitted. This digital object may be retained by the institution that produced it or disseminated to others.

As shown in FIG. 1, for security or other reasons, the authorized institution 22 may choose to retain the digital object in a protected location and never issue, circulate or otherwise make it available to outside parties. In the figure, we refer to this initial digital object 24 as an “a-DO”. In many applications, there may be no requirement or need for a digital object that is not to be issued, circulated or otherwise made available publicly, in which case there would be no a-DO and the creation of the digital object would start with a digital object intended for dissemination (“b-DO”) 26 as described below.

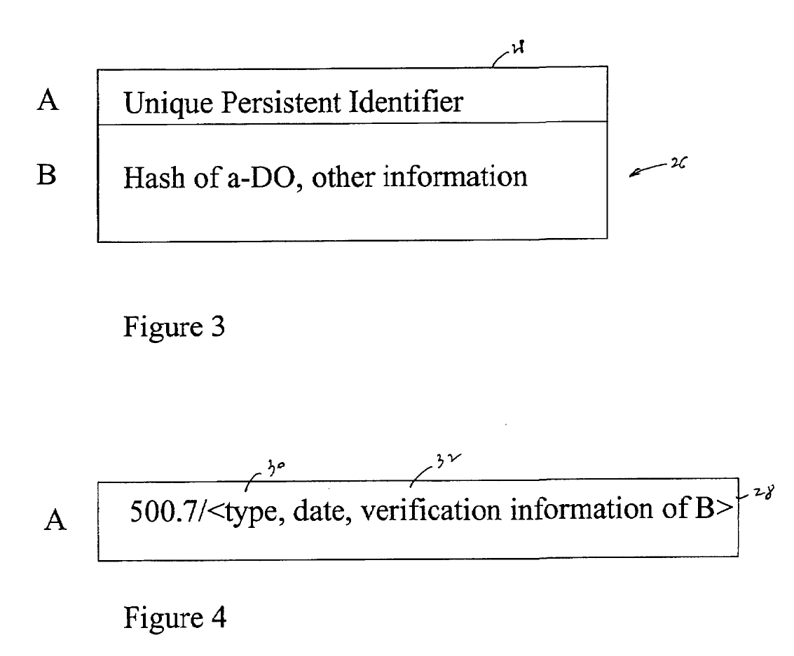

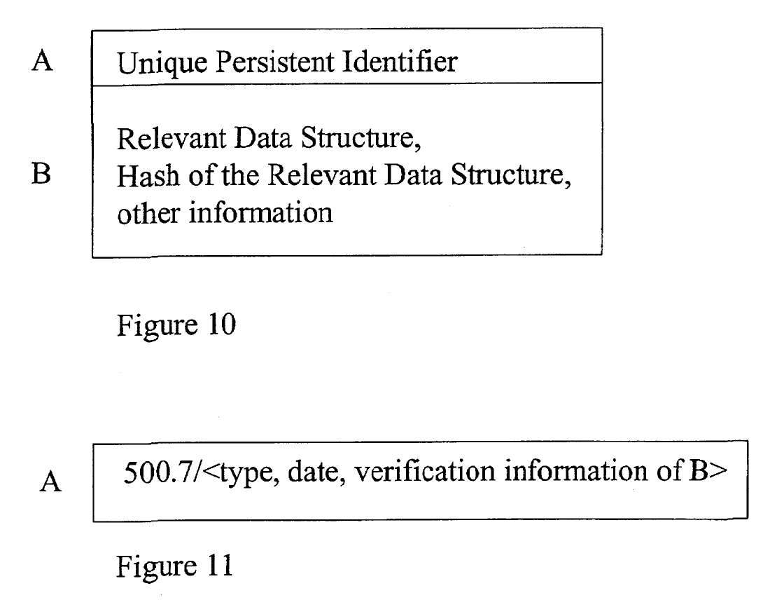

The b-DO 26 is a new digital object of value, shown in FIG. 3 (its identifier 28 being shown in FIG. 4) that is produced for purposes of dissemination to the public or a limited portion of the public. If an a-DO existed, the b-DO may derive certain elements from the a-DO for verification, control, and security purposes. For example, a “hash” of an a-DO may be included in the data body of a b-DO. As shown in FIG. 10, if there is no a-DO, a cryptographic hash may be created from an informal data structure 11 that is not a digital object (whether or not retained in a data base or other storage system), or the hash may be created randomly. The hash may also include a digital signature, along with other information, if desired.

The identifier 28 for the b-DO, which is included in the b-DO, will generally contain enough information to indicate what it identifies (e.g., a type such as a ten dollar digital object), a serial number, and information 32 useful in authenticating the rest of the object. The information 32 includes, for example, a fingerprint of the b-DO data body in the identifier of the b-DO. A party who receives the identifier for the ten dollar object at the start of a transaction that includes the use of the ten dollar object as a payment, say, could resolve the identifier by presenting it to the handle system, obtain the b-DO, and determine that the fingerprint authenticates the data body of the b-DO.

The notion of one-way functions is widely known. These are algorithms that are easy to apply in one direction, but cryptographically hard to apply in the other direction. If the length of the fingerprint and the data body are both chosen properly, an effort to form a matching data body to a given fingerprint can be made cryptographically difficult.

One benefit of using both a b-DO and an a-DO is to be able to diagnose isolated (or systemic) cases of fraud, or corruption of the b-DO. This can be accomplished by comparison of the b-DO with the a-DO, so that fraud or corruption can be detected downstream in the process. By disseminating a b-DO instead of an a-DO to the public, the detailed design of the data structure of the a-DO can be kept largely out of public view. It also allows for public use of smaller data structures in the b-DO than may be desirable in the a-DO.

The b-DO is not usually intended to be sent directly to the public, although it can be used that way. One reason is that the institution that produced the b-DO may not want to deal with individuals or the public at large. The institution may only want to deal with intermediate organizations, such as state or local branch banks, which, in turn, might deal with individuals, and/or other organizations.

Upon being received by a bank (BK), the bank may create its own digital objects for circulation to the public using the b-DO as its basis for so doing. The digital objects to be circulated by the bank are referred to here as digital objects intended for circulation to the public (“c-DOs”). The c-DO may derive certain elements from the b-DO for verification, control and security purposes. The use of c-DOs would not be required if the b-DOs are allowed to be issued to the public.

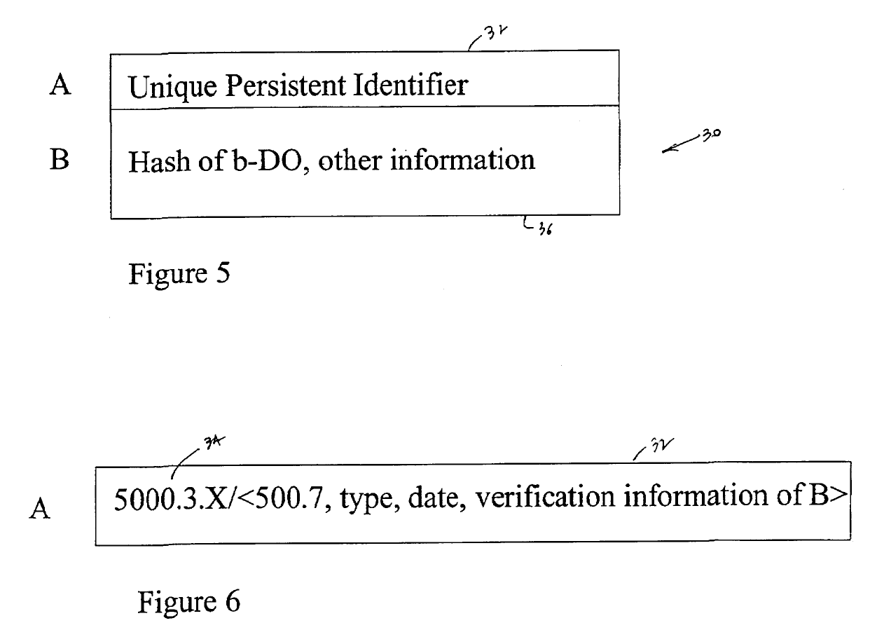

Following the example of the ten dollar digital object, BK creates new ten dollar object (c-DO) 30 having the data structure shown in FIG. 5 (the identifier 32 of which is shown in FIG. 6). The primary prefix 34 for BK is assumed to be 5000 in this example, and 5000.3 corresponds to a particular branch of the bank. 5000.3.X might denote the particular individual who has access to the object at any time, or it might refer to a particular serial number for a ten dollar object.

Administrative changes to any handle record in the handle system require use of a private key corresponding to the public key of that handle record. The data body in FIG. 5 is produced by BK and not by the institution that provided the b-DO to the bank. The data body 36 may also contain a digital signature of BK. Corruption in the c-DO may be traced back to the appropriate bank branch (at least) and diagnosed by comparing each c-DO, if possible, with the b-DO from which it was generated. This would be possible if the identifier was not corrupted. The use of error detection and correction techniques could also be helpful in diagnosis, especially if the identifier becomes corrupted.

Payment Using a C-DO

At the time of issuance to a party, BK or a division of BK moves the digital object of value to a computational facility designated by the party to whom the c-DO is issued, arranges to have the identifier provided to the party, and arranges to have the party's public key entered into the handle system along with the identity of the administrator (which may be the party, himself or it may be anonymous) and the identity of the party's computational facility. The BK could ask the party to provide the public key directly to the handle system, or the BK could provide the public key on behalf of the user. The choice of a user's public/private key pair could be made by the party or be generated by the handle system in some fashion, or by some other system.

In the discussion that follows, we shall assume the c-DO to be transferred as follows. BK provides a user, called party A, the c-DO plus an authorization string that is based on the private key of BK. The authorization string is in a form that the handle system will accept as the basis for making changes to the relevant public key and other administrative information as requested by party A. Once the c-DO has been issued to party A, and the changes have been made to the handle system to reflect the new owner, the c-DO can be transferred from party A to party B (and so forth) in the following similar way.

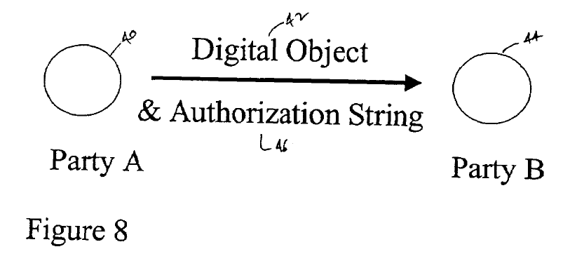

As shown in FIG. 8, party A 40, who is the only party now able to make changes to the handle record for the c-DO 42, arranges to transfer the c-DO or only the identifier of the c-DO to party B 44. The identifier for the c-DO may have been made known by party A to party B during the course of the transaction. The transfer could be made to a hand-held device or other local device of party B, which can be displayed to party A, or it could be made to a remote computational facility of party B's choosing. Along with the c-DO or its identifier, party A also provides to party B, in digital form, an authorization string 46 (based on the private key of party A).

Using the authorization string, party B may cause the handle system to change the handle record so that administrative access to the handle record for the c-DO is now available only using party B's private key, and to insert the identity (e.g., network address or handle) of party B's computational facility in the handle record in lieu of the identity party A's computational facility. To the public, the ten dollar c-DO is now controlled by party B's public key and by party B's computational facility. During this process, party A may also provide party B with the c-DO's identifier, separate from the c-DO, for convenience, for ready reference to the c-DO, and as a shortcut way of conveying the c-DO.

The only change that party B is allowed to make in the handle system is to change the designated computational facility, the public key, and such other administrative information as the handle system may require. Party B cannot change the identifier (or any part of the data body portion of the digital object) or otherwise delete the handle record.

The above examples show the progression from an a-DO, a digital object that is not intended for circulation, to a b-DO, which may be an abbreviated version of a-DO or independently generated, and which is intended to be circulated to the public or a segment of the public, to a c-DO, which is intended for wide circulation and re-transfer from party to party, and then to using only the identifier for the c-DO in lieu of the c-DO itself.

If payment information were to be contained in a local computation facility, such as a digital wallet, only the identifiers would need to be stored in the wallet. The c-DOs could be stored in a trusted 24-hours a day, seven days a week computational facility.

However, it is also possible that digital wallets will have sufficient memory to allow larger digital objects to be stored there for subsequent circulation in commerce. In that case, the digital wallets would constitute the trusted computational facility even if they were not available 24×7. However, if the wallets could hold the entire digital objects, there may be no reason to use only the identifiers, as the whole digital object could be presented from party A to party B. If party B also has such a digital wallet with limited memory, and the whole digital objects are too large for the party B's local memory, the use of identifiers may again be necessitated.

Confirming a Transfer

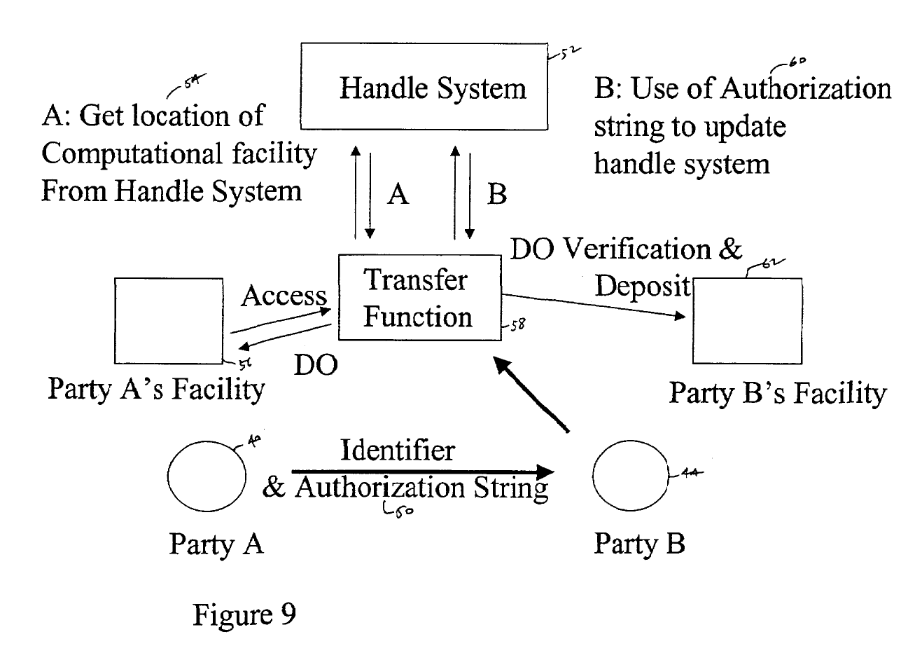

As shown in FIG. 9, once the c-DO, or the identifier 50 for the c-DO has been passed from party A 40 to party B 44, party B can check to determine, before the transaction is completed, if the fingerprint in the identifier verifies the data body of the c-DO. If only the identifier is transferred, party B can present it to the handle system 52 for resolution, and obtain the address or other location 54 of party A's computational facility 56. Party B gets the c-DO from party A's computational facility and uses the publicly known cryptographic algorithm of the issuing bank to form a fingerprint of the data body of the c-DO, which party B then matches against the fingerprint that is part of the associated identifier. If the c-DO is not produced by the facility, the transaction does not proceed further. The use of a fingerprint in the identifier precludes the need for party A or party B to go back to the bank, or to some other party, to verify the c-DO.

The bank is assumed to make known, publicly, the algorithm it uses to fingerprint its digital objects. The algorithm may change from time to time. Old digital objects may be recalled by the bank from time to time and reissued to provide stronger protection. All the banks may use a common fingerprinting mechanism at any given time.

After an object's authenticity has been determined, the handle system administrative information must be updated to make use of the public key of party B and not to continue using the public key of party A.

If the handle system informs party B that the computational facility of party A is carried or controlled directly by party A (i.e., his digital wallet or PDA or the like), then party B may wish to verify, up front, that party A has control of the handle record for that identifier. Party B can verify this fact after the change has been made from party A's public key to party B's public key by invoking a command of the handle system that can only be supplied by the party in control using his private key to communicate with the handle system. However, even prior to the change of private keys, party B could learn from the handle record something observable on the spot, such as the serial number of the PDA or equivalent physical information. If the prior check of the handle system is fraudulent but not detected, party B will soon learn that party A did not have the ability to enter party B's public key into the system and the transaction will fail.

The above description has generally indicated steps that need to take place. In general, these steps could be carried out automatically by computational systems. The steps could be automated and optimized in a wide variety of ways. In general, implementations could take account of the fact that parties do not want to have to remember lengthy identifiers or public keys and would entrust those functions that involve the identifiers or public keys to their equipment or banks or other trusted parties, as appropriate.

For example, upon receiving an identifier from party A that is purported to be worth $10, party B could forward the identifier plus authorization string to an authorization agent 58 for approval without having to perform all the steps beforehand. Of course, the authorization agent would need to know more than just the identifier and authentication string of party A. The authorization agent would have to know the computational facility 62 of party B to insert it into the handle system, and to do that it would have to be given access to change the handle system record by party A. Once this has occurred, the agent could take the steps to transfer the digital object, to make the handle record changes 60, and to inform party B that the transaction went through. This could take at most a few seconds in practice. In principle, party A and party B could complete the transaction without recourse to a separate authorizing agent but they would have to cooperate to carry out the various steps themselves.

If an unreliable or even dishonest computational facility were to issue a wrong c-DO corresponding to a given identifier, the recipient would know immediately by using the fingerprint in the identifier to verify the c-DO. The bank, or another organization, could also provide a trusted service by which it could certify to a party that the fingerprint in the identifier of a c-DO corresponds to the data body portion of the c-DO.

If party A attempts to convey a copy of a c-DO that he once owned but previously transferred to someone else, it will not be possible for him to effect the requisite public key change in the handle system, because he no longer controls access to the handle record for that identifier. Party A might try to use a copy of a digital object retained after a prior transfer, but the handle system would not cooperate. The handle system would give the identity of a different computational facility than the one authorized by the current owner of the c-DO. In any event, party A could not make the necessary changes to the handle record to complete the transfer. Of course, a user who entrusts his c-DOs with an untrustworthy computational facility may lose the value if the facility cannot produce the c-DOs, just as one who gives his money to an untrustworthy bank can lose his asset if the bank does not retain a record of the deposits. A trustworthy facility will only provide a c-DO to the real owner based on his instructions and the use of an adequate access control scheme.

The system thus has two key trust requirements to work correctly: the handle system must be trustworthy to protect against fraud; and the computational facilities must be trustworthy so as not to lose value for the parties.

Other features could be provided in the system.

A time limit could be imposed on the validity of a digital object, perhaps requiring the owner to renew it periodically. This might also be a way to check on possible misuse of the digital object in the interim.

It could be useful to create a mechanism for withdrawing, replacing, or reissuing a digital object. This might be desirable if the cryptographic strength of older formats were to be sufficiently weakened, and it became desirable to replace old digital objects with new ones. For example, a bank could systematically check its issued identifiers (assuming it retained records of them or the handle system allowed the bank to access the handle records that corresponded to all the identifiers created by the bank) to locate the computational facility of the current owner of each c-DO or b-DO. The bank could then interact with those facilities to make the relevant exchanges (e.g., withdrawal and reissue). The computational facility, in turn, could notify the party that owns the object being withdrawn, replaced, or reissued to contact the bank, or the bank could be empowered by the party to take all the relevant actions on the party's behalf.

Even though the data structure of the digital object may be technically retained by a party after the party has transferred it to another party, there is a notion of one of the digital objects intended for dissemination or circulation to the public as being the “original” one, whether an ab-DO, b-DO,or c-DO, such that one can know where the original digital object is, determine that it is the original one, and pass the original one from one party to another party, anonymously if desired. The location of the original digital object (i.e. the location of the computational facility (designated by the party in control of the authorized object) would be identified by the handle system in a secure fashion; and in a transaction between two parties to move a digital object, the digital object being moved may be understood by the parties to be the original digital object.

In some cases, the party having the authorized object may wish to store it in several computational facilities, which could all be made known to the handle system. In such cases, any of these instances of the digital object could be considered to be potentially authorized since any one of them could serve to deliver the authorized data structure; and the handle system can allow only one of them to be used in the transfer of the digital object to another party. In this case, the party receiving the authorized data structure would now have the original digital object.

In the case of multiple originals, such as might be the case with wills, each party having ownership of an original digital object may store it in one or more computational facilities. In such cases, each party would, in essence, be a separate administrator (with a separate public/private key pair) for the identifier and the set of computational facilities used by each party would be separately designated.

The identity of the computational facility holding a given digital object does not expose the identity of the party then owning a given digital object, nor is the identity of the owner exposed by the existence of a public key that is only used for internal administrative purposes in the handle system. A random party cannot determine the public key for a given handle record unless the party controls that handle record.

Among the advantages of the techniques described above are the following. A party who receives a digital object can verify the integrity of the data body portion of the object (and thus its authenticity) easily without having to go back to the originating institution or the issuer. A party would have difficulty setting himself up as a rogue issuer able to infuse the system with invalid digital objects. It is cryptographically difficult for a party who, without authorization, retains or otherwise comes into possession of an authentic digital object to pass himself off as the legitimate owner or controller of the object.

Forming Composite Digital Objects

In the examples above, it is assumed that a digital object incorporates information is which a party has rights or interests, or in which there is value determined, most likely, by the organization that created it. As shown in FIG. 11, in this section, we assume that there are preexisting resources 13 (whether in digital form or not) having value, and that a new data structure is created comprising a bundling of the designated resources and where the rights, interests or value is intrinsically linked to some function of the resources, such as the sum of the values of the bundled resources. A digital object is then produced, whose identifier 15 contains verification information sufficient to verify its data body. The data body 17 is the above mentioned data structure, which may include basic information about the bundled resources, hashing and other information such as additional security information.

The digital object is then disseminated to another party. In this case, each resource in the bundle is given an identifier that corresponds to the resource in digital form or to a set of descriptive material in digital form that adequately describes the resource. The party that bundles the resources asserts that it has the right to bundle the resources, either because it owns all the resources, or has permission from the owners to bundle the resources. For example, the bundle may contain information representing mortgages to be sold on the secondary market.

An initial digital object may be created for the bundled resources that includes an identifier and a data body (including an optional digital signature). The data body incorporates the set of bundled resources, their descriptions (if the resources themselves are not otherwise available in digital form), their identifiers, or some combination of the above.

A digital object intended for limited dissemination (b-DO) may not be required in this case, if the organization that created the initial digital object (as an alternate form of a-DO) allows it to be used to deal directly with the other participating organizations that care to trade in this kind of composite digital object. If there is no a-DO, a b-DO is created as before, with the identifier containing the verification information for the data body, and other information, as appropriate. If no a-DO is required, the c-DO can be directly created from the b-DO. Indeed, in this case, there may be no need for a c-DO at all.

Finally, a c-DO may represent certain operations performed on a b-DO. For example, a c-DO could represent a partial share in a b-DO and could be issued by an authorized institution.

Other implementations are also within the scope of the following claims.

1. A method comprising
authenticating one or more portions of a digital object using verification information contained in a unique persistent identifier for the object as a whole,

2. The method of claim 1 in which the verification information is over the portion or portions of the digital object not including the object's identifier.

3. A medium bearing a unique persistent identifier associated with a digital object, the identifier including information derived from the digital object and sufficient to enable a machine to verify that the digital object with which the identifier is associated is unchanged from what it was at an earlier point in time.

4. The method of claim 1 in which one or more portions of the digital object comprise a separate digital object having an associated unique persistent identifier, the unique persistent identifier including verification information.

5. A method comprising
forming a digital object including a determinable portion or portions containing a hash of another digital object, the hash being cryptographically generated, and
including in the identifier of the object as a whole, verification information for portions of the digital object including the determinable portion or portions containing the hash.

6. The method of claim 5 in which the hash includes a digital signature.

7. The method of claim 5 in which the digital object comprises other digital objects each with an identifier and verification information.

8. The methods of claims 1 or 5 also including identifying fraud or data corruption using data derived from the previously existing digital object.

9. The method of claims 1 or 5 also including withholding the previously existing digital objects from public dissemination.

10. The method of claim 5 in which a holder of the digital object cannot access the portions of the incorporated digital objects including their identifiers to verify the content of each of the digital objects included in the whole.

11. The method of claim 5 in which the digital object comprises identifiers of one or more of the identifiable digital objects.

12. A method comprising
determining an identity of a computational facility in which a digital object is stored and from which it can be accessed using an identifier of the digital object and a network-based identifier resolution system, the identifier including information from which the digital object can be verified.

13. The method of claim 1, 5, or 12 comprising using a cryptographically controlled identifier resolution mechanism to confirm an owner of a digital object based on the identifier of the digital object.

14. A method comprising
transferring a digital object from one party to another by conveying an authorization string and a unique identifier of the digital object, the digital object being remotely accessed for purposes of verification, the authorization string being used to invoke change of control in a resolution system based on the identifier, the control being changed without an issuer of the digital object being required to be involved in the change.

15. The method of claim 14 in which the digital object comprises an original and also including tracking the transfer of the digital object from place to place over time.

16. The method of claim 14 in which the digital object comprises an original, the method also including transferring duplicates of the original.

17. The method of claim 14 in which the change of control includes transferring the digital object from the one party to the other.

18. The method of claim 14 in which an instance of a digital object, on being initially created, can be tracked throughout the system

19. A method comprising
publishing by an authorized party of an algorithm for use in verifying the authenticity of digital objects.

20. A method comprising
based on current identifiers of digital objects, using a resolution mechanism to contact computational facilities containing the digital objects,
producing and sending replacement digital objects to these facilities,
inserting revised information about the identity of new computational facilities and new identifiers for the replacement digital objects in the resolution system, and
rendering prior information about computational facilities and public keys invalid by revoking access to the resolution system with respect to the old identifiers by the current owners.

21. A method comprising
forming a data body,
forming information based on the data body from which the authenticity of the data body may be verified,
forming a digital object including the data body,
forming an identifier of the digital object, the identifier including the verification information, and
transferring the digital object to a computational facility.

22. A method comprising
comparing a digital object with a pre-existing digital object from which it was derived, and
determining an existence of fraud based on the results of the comparison.

23. The method of claim 22 in which the existence of fraud in a digital object is determined by comparing the digital object from which it was derived with an ancestor digital object from which it was derived.

24. A method comprising
publishing by a party that originates a digital object of a fingerprinting algorithm for use in verifying the authenticity of at least a portion of the digital object.
